(19) United States
(12) Patent Application Publication
(10) Pub. No.: US 2007/0076157 A1
(43) Pub. Date: Apr. 5, 2007

(54) Structure of liquid crystal display with a wide viewing angle

(75) Inventors: Wen-Chun Wang, Taichung City (TW); Ming-Chang Yu, Taichung City (TW); Henta Kang, Taichung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/242,069

(22) Filed: Oct. 4, 2005

(51) Int. Cl. G02F 1/1343

(52) U.S. Cl. 349/143

(57) ABSTRACT

A structure of liquid crystal display (LCD) with a wide viewing angle is presented. In this invention, a slit pattern of a pixel electrode is definded by using an etching process. Thereafter, a reflection layer which defines a reflective region and a transmissive region is constructed along the top or bottom of the slit of the pixel electrode, and wherein a slit or bump pattern can be included in the top electrode further. Therefore, by adjusting the relative positions of the slit or bump structures in the electrodes and by using the fringe effect of electric field, the tilt direction of the LC molecules in a LC cell is controlled and the effect of semi-transmitted wide viewing angle of multi-domain division is formed.

### FILED OF THE INVENTION

The invention presents a kind of structure of LCD (liquid crystal display) with a wide viewing angle. The point is that the technology of wide viewing angle with multi-domain division and build-in refective function is constructed.

### BACKGROUND OF THE INVENTION

An impediment to the use of conventional LCD is the limited viewing angle problem, which allows for a good vision with viewing angles of 45 degree from center left to right. However, for the development of faceplates with larger dimensions and wider applications and for the strict requirement of visional reception, it is important for a LCD with a wide viewing angle.

There are two technologies for a wide viewing angle.

One is an external adhesive mode and the other is a build-in mode (e.g., Multi-domain Vertical Alignment (MVA), In Plane Switchin (IPS)). The American patent U.S. Pat. No. 6,380,996 “Optical compensatory sheet and liquid crystal display” uses a transparent compensatory film with a dual index of refraction (□n<0) to compesate the phase delay from the TN LC cell, so that the purpose of wide viewing angle is achieved, as shown in FIG. 1. Although the external adhesive mode can promot the viewing angle with precision diffusers, the diffusers are fixed and can't compensate any gray-scale and any angle. So, the natual gray-scale transformation in TN LCD still exists.

U.S. Pat. No. 6,661,488 “Vertically-aligned (VA) liquid crystal display device” proposed a kind of protrusion-like bump to produce a pretilt angle by the LC itself, as shown in FIG. 2. When the vertex angle of the bump becomes larger, the tilt angle of the long axis of a molecule becomes smaller.

FIG. 3 shows a kind of LCD with a dual domain MVA mode. When the voltage is off, the long axis of LC molecule is perpendicular to the screen and only the molecule close to the bump electrode is tilt a little, so that the light can not pass through the top and the bottom polarizers. When the voltage is on, the molecules close to the bump electrode, together with other molecules, are twisted and perpendicular to the surface of the bump immediately, i.e. the long axes of molecules are tilt to the screen. Therefore, the transmittance is going up to realize the light adjustment. Since the adjacent LC molecules in the dual-domain mode are symmetric and the long axes point to different directions, the compensation of light can be achieved in the MVA mode.

The practical vision effect is medium gray-scale in the view looking B and is high gray-scale or low gray-scale in the view looking A and C, as shown in FIG. 4. However, before the compensation of light, the viewing angle can be modified only in the up, down, left and right directions by MVA mode, and the other directions are not ideal. Even looking at the screen with very large viewing angle in the special orientation, the transformation of gray-scale occurs. The strength of electric fields is not uniform due to the special arrangment of the electrodes, and which can make the gray-scale display incorrect. It is necessary to increase the drive voltage up to 13.5V to control the rotation of LC molecules precisively, so a lot of power is wasted.

U.S. Pat. No. 5,598,285 ┌Liquid crystal display device┘ is an IPS mode, wherein the strip-like electrodes are placed parallel to the substrate, as shown in FIG. 5. When the voltage is applied to the electrodes, the LC molecules initially arranged along the horizontal electrode reorient themselves in the direction perpendicular to the electrode, and the long axes of the LC molecules are still paralleled to the substrate. The LC molecules can rotate to the specified angles by contolling the voltages, and the polarizers can adjust the transmittance of the polarized light, so that different color scales can display. The LC molecules are not twist-nematic type, but their long axes are paralleled to the substrate.

Since the electrodes of the IPS mode are on the same side of the substrae but not on both sides as other LC modes, the in-plane electric field is constructed to drive LC molecules with lateral motions. When the voltage is applied to the electrode, the LC molecules nearby the electrode get much power to twist 90 degree immediately. However, the LC molecules far from the electrode can not get the same power, so the motion is slow. Only increasing the drive voltage, the LC molecules far from the electrodecan can get enough power. Therefore, the drive voltage for the IPS mode is high, and typically is about 15 volt. Besides, the IPS mode needs more backlight lamps, because the in-plane electrode will reduce the ratio of the slit and the transmittance.

The semi-transmissive LCD involves the merits of the transmissive LCD and the reflective LCD. In order to have the semi-transmissive effect, the American patent U.S. Pat. No. 6,195,140 ┌Liquid crystal display in which at least one pixel includes both a transmissive region and reflective region┘ proposed a kind of technique with dual cell gap. The cell gap of the transmissive region and reflective region in the pixel is divided into different gap heights. When d_{R}=d_{T}/2, the transmissive region and reflective region have the same difference of optical path, as shown in FIG. 6.

In addition, a kind of transmissive and reflective LCD is applied to the LC device with single cell gap, which is added a micro reflective film on the surface of the bottom plate, as shown in FIG. 7. The micro reflective film allows light to pass through the bottom. When light incidents from the top, the light will reflect by the micro reflective film. However, the efficiency of usage can't achieve the predicted result.

### SUMMARY OF THE INVENTION

Therefore, in order to solve the above problems, the main purpose of this invention is to control the different tilt directions of the LC molecules by using the fringe effect of electric field in vertical direction, so that the vertical alignment of multi-domain division is formed and the transmissive region and reflective region in the pixel electrode are defined, thereby the wide viewing angle LCD with reflective effect is constructed.

Another purpose of the invention is to form a wide viewing angle LCD with reflective effect of the structure of the semi-transmissive LCD. Since the LCD has the merits of the reflective and transmissive LCDs, the definition and power saving can be achieved at indoor and outdoor conditions.

In this invention, a pixel electrode is established on the first substrate, and a slit pattern of the pixel electrode is definded by using an etching process. A reflection layer that defines the reflective and transmissive regions formed along the top or bottom of the slit of the pixel electrode, and the reflective layer is covered with a polarizing layer. A top electrode and a polarizer are established on the second substrate. The polarization axis of the polarizer is orthogonal to the polarizing layer, and the top electrode includes a slit or bump pattern structure. Therefore, by adjusting the relative positions of the slit or bump structures of the electrodes and by using the fringe effect of the electric field, the tilt direction of the molecule in the LC cell is controlled and the alignment of multi-domain division is constructed. At the same time, a semi-transmissive LCD with both reflective and transmissive regions is formed, so that good definition and power saving can be achieved at indoor and outdoor conditions.

### BRIEF DESCRIPTION OF THE DRAWINGS

FIG. 1 shows the schematic diagram of a compensatory film with an external adhesive mode.

FIG. 2 shows the schematic diagram of a LCD with a build-in MVA mode.

FIG. 3 shows the schematic diagram of a LCD with a build-in MVA mode.

FIG. 4 shows the schematic diagram of real visional effect of a LC with a build-in MVA mode.

FIG. 5 shows the schematic diagram of a LCD with a build-in IPS mode.

FIG. 6 shows the schematic diagram of a dual cell gap LCD.

FIG. 7 shows the schematic diagram of a single cell gap LCD.

FIG. 8 shows the first schematic diagram of the LCD structure in the invention.

FIG. 9 shows the top-view schematic diagram of the LCD pixel in the invention.

FIGS. 10A to 10G show the top-view schematic diagrams of the slits of the pixel electrode and top electrode.

FIGS. 11A to 11G show the schematic diagrams of the relative positions of the slits.

FIG. 12 shows the schematic diagram of the invention without applied voltages.

FIG. 13 shows the schematic diagram of the invention with applied voltages.

FIG. 14 shows the second schematic diagram of the LCD structure in the invention.

FIG. 15 shows the third schematic diagram of the LCD structure in the invention.

FIG. 16 shows the fourth schematic diagram of the LCD structure in the invention.

FIG. 17 shows the fifth schematic diagram of the LCD structure in the invention.

FIG. 18 shows the sixth schematic diagram of the LCD structure in the invention.

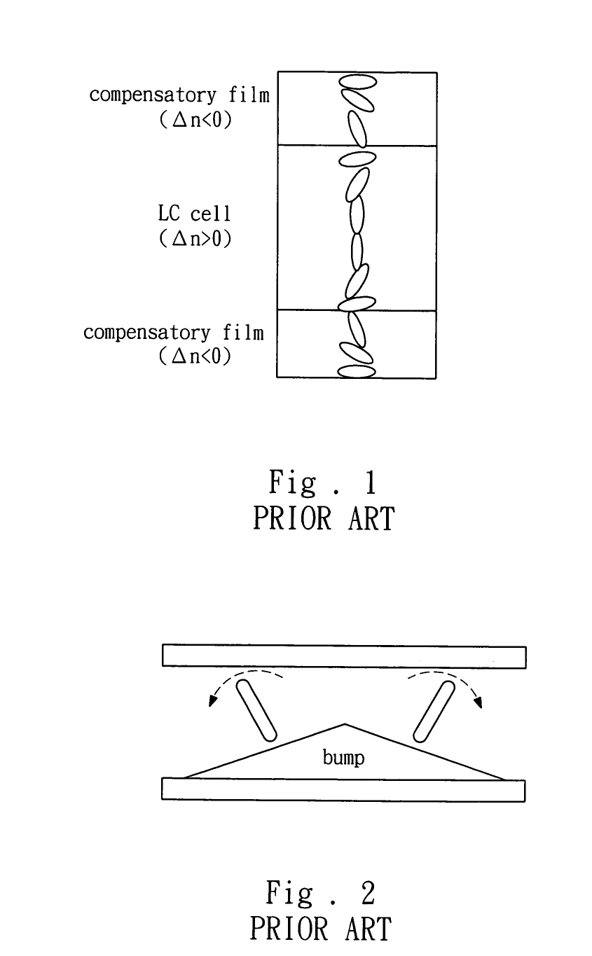

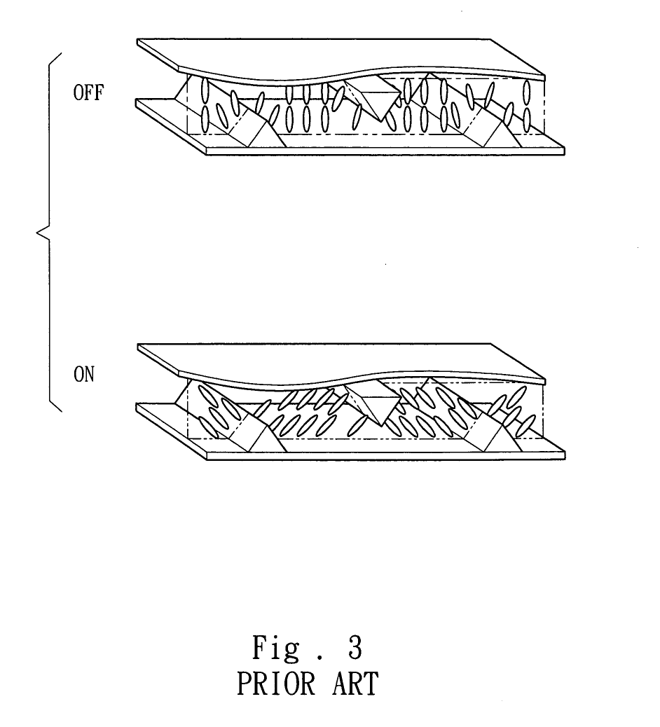

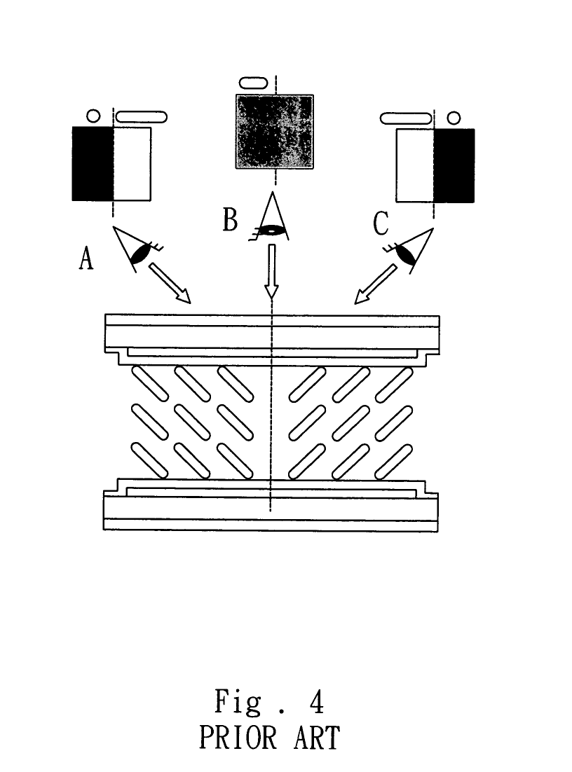

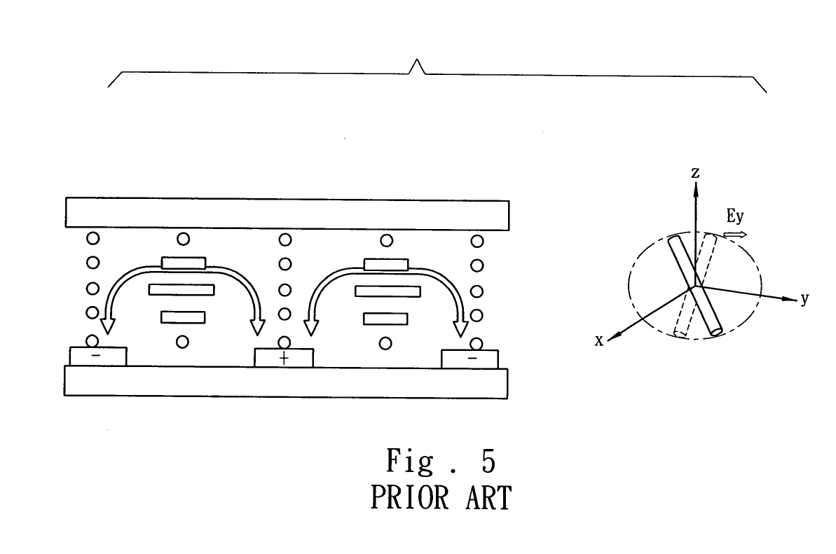

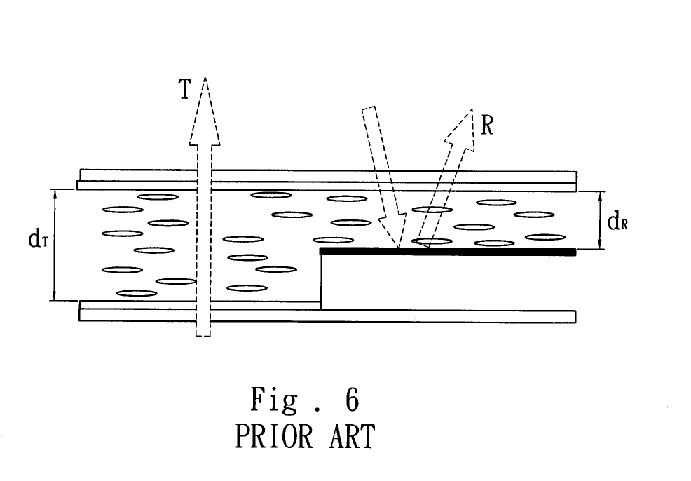

### DETAILED DESCRIPTION OF THE PREFERRED EMBODIMENTS

The detail contents and illustrations of the technologies of the invention are given below.

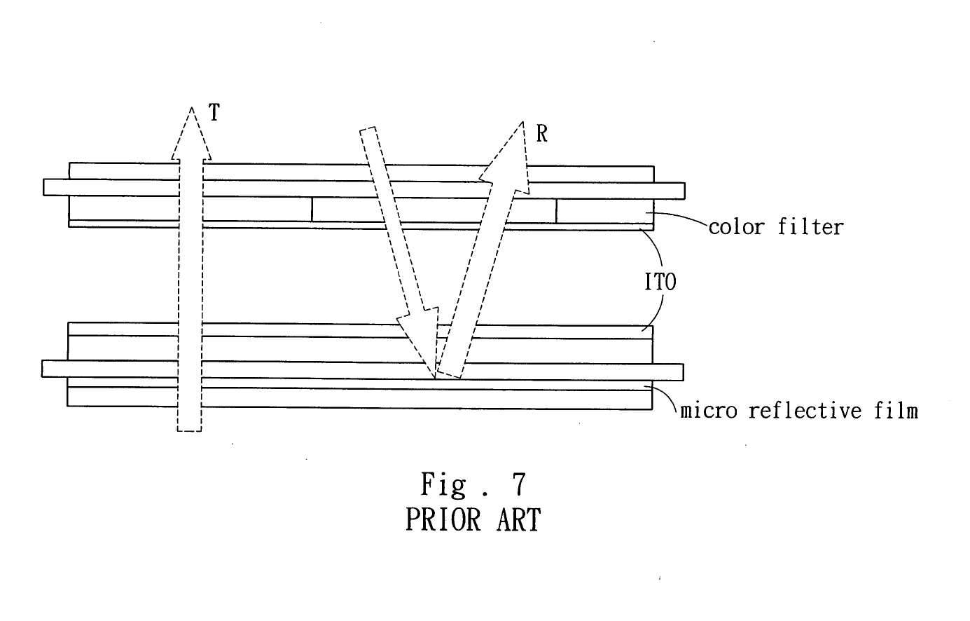

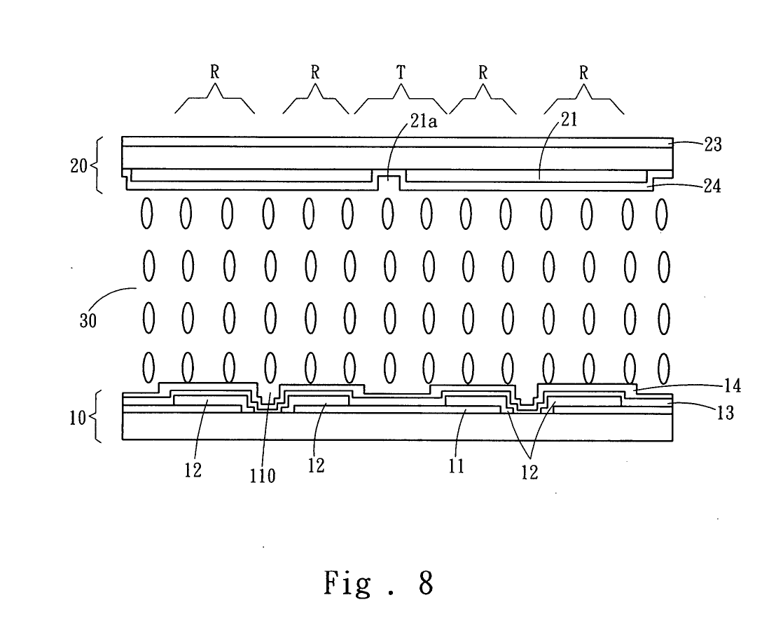

FIG. 8 shows the first schematic diagram of the LCD structure of the invention. The structure contains the first substrate 10 with a TFT (thin firm transistor) on the surface. A pixel electrode 11 is estabished on the first substrate, and a slit pattern 110 of the pixel electrode 11 is definded by using an etching process. A reflection layer 12 that defines the reflective region R and transmissive region T is deposited partially on the pixel electrode 11 along the boundary of the slit 110. The reflection layer 12 is a metal material (e.g., Al, Ag, Cr, AlNd and so on) with low resistivity and high reflection character. The reflection layer 12 and the pixel electrode 11 are covered with a polarizing layer 13, and finally the plarizing layer 13 is covered with the first alignment film 14.

The second substrate 20 with a color filter has a top electrode 21, and a polarizer 23 is on the outside surface of the second substrae 20. The polarization axis of the polarizer 23 is orthogonal to the polarizing layer 13. The top electrode 21 has a slit structure 21a, and the slit structure 21a contains at least one point-like slit. The top electrode 21 and the slit structure 21a are covered with the second alignment film 24, and the slit structure 21a and the slit structure 110 of the pixel electrode 11 are separated in the vertival direction, i.e. the slit structure 21a of the top electrode 21 and the slit structure 110 of the pixel electrode 11 do not overlap each other. FIG. 9 shows that the slit structures 110 and 21a are formed in the center of the pixel electrode. Finally, the LC cells 30 are established between the first substrate 10 and the second substrae 20.

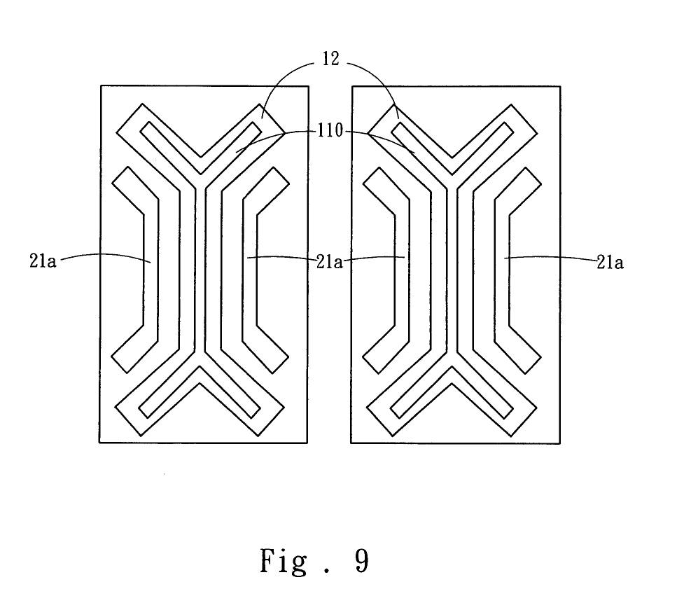

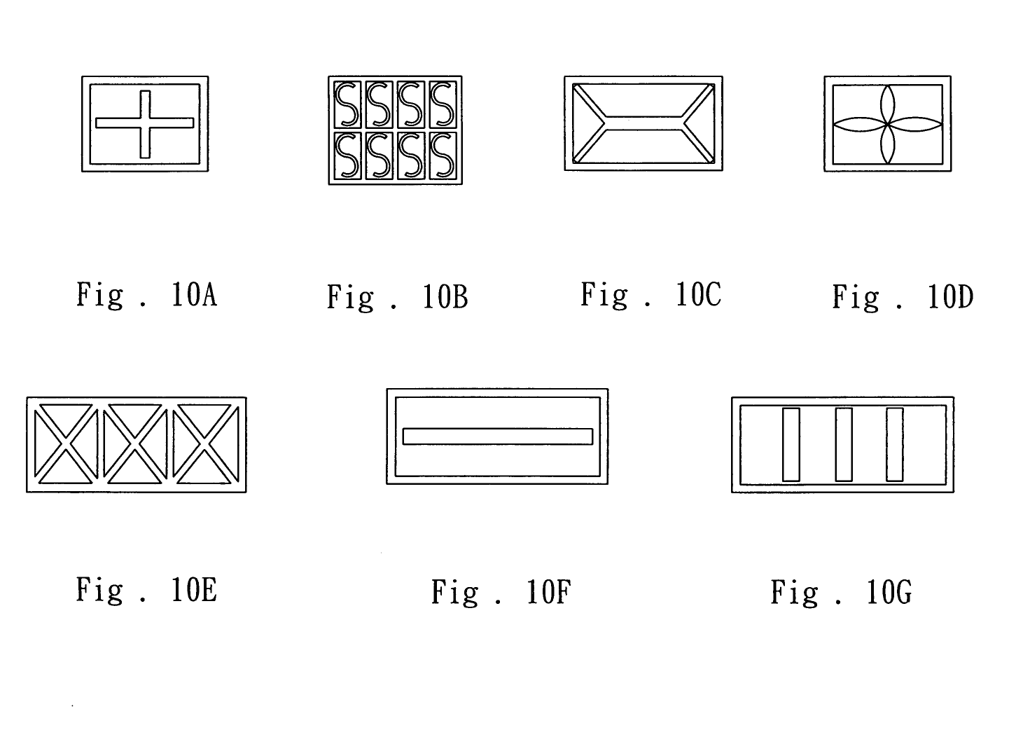

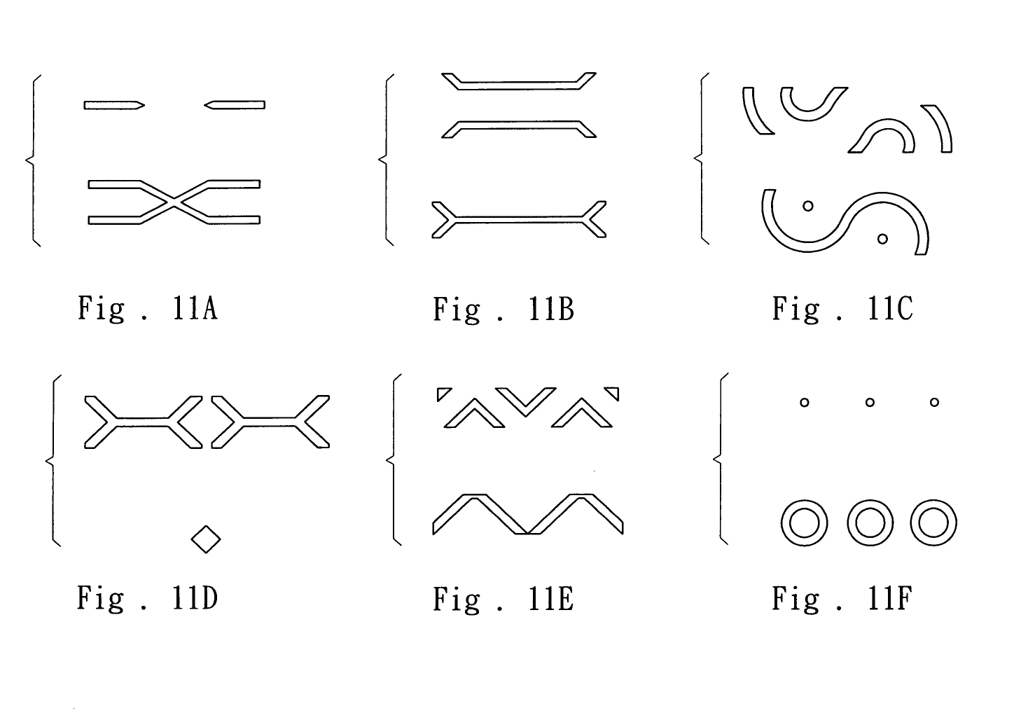

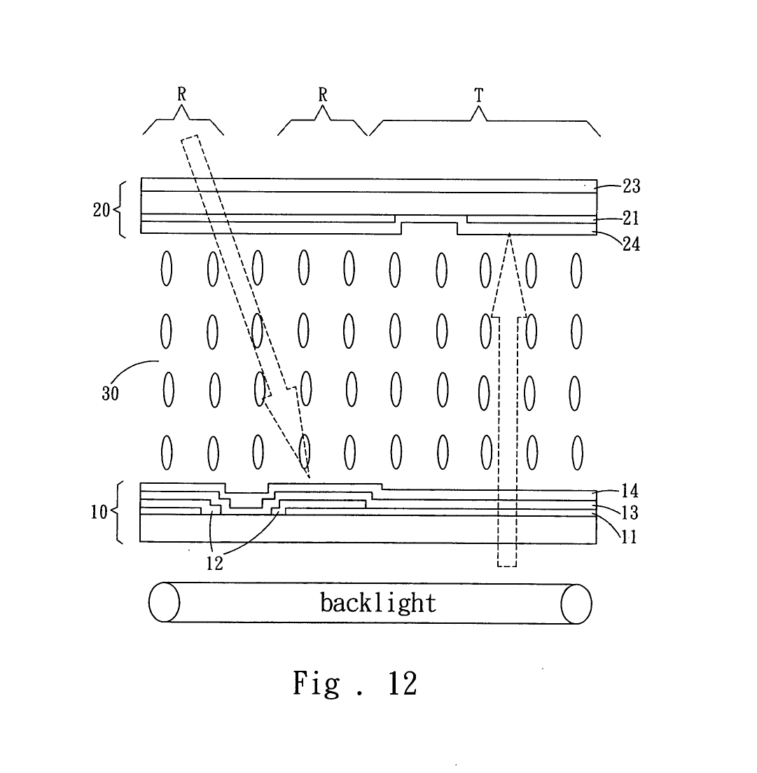

There are two portions of the statement of the invention. In wide viewing angle, by adjusting the relative positions between the slit structure 110 of the pixel electrode 11 on the first substrate 10 and the slit structure 21a of the pixel electrode 21 on the second substrate 20, the slit structure 21a and the slit structure 110 are separated in the vertival direction. The patterns of the slit structures 110 and 21a can be the combination of the cross shape, herringbone shape, ] shape, [ shape, < shape, X shape, S shape, petal shape, horizontal configuration shape, or vertical slot shape, as shown from FIGS. 10A to 10G and from FIGS. 11A to 11F. By adjusting the relative positions between the slits 110 and 21a and by using the fringe effect of electric field of the two slit structures to control the tilt direction of the LC molecules in the LC cell 30, the effect of semi-transmissive wide viewing angle with multi-domain division is formed.

In reflective function, the outside light is reflected by the reflection layer 12 around the slit structure 110 of the pixel electrode 11. When the light passes through the polarizer 23, the LC cell 30 and the polarizing layer 13, the reflective region R and the transmissive region T have the same polarzation state to achieve the effect of semi-transmission and semi-reflection.

As FIG. 12 indicates, when the driving voltage is not applied to the LC, the arrangement of the long axes of the LC molecules in the LC cell 30 is perpendicular to the second substrate 20 and the first substrate 10. When the backlight passes through the polarizing layer 13 and the LC cells 30 and arrives at the second substrate 20, the polarization direction of the polarized light is perpendicular to the polarization axis of the porlarizer 23 on the second substrate 20, so that the light is cut off to produce a dark frame. Similarly, the arrangement of the long axes of the LC molecules in the LC cell 30 is perpendicular to the second substrate 20 and the first substrate 10 in the reflective region. When the outside light passes through the polarizer 23 on the surface of the second substrate 20 and through the LC cells 30, the polarization direction of the polarized light is perpendicular to the polarization axis of the porlarizing layer 13 on the first substrate 10, so that the incident light is absorbed to produce a dark frame.

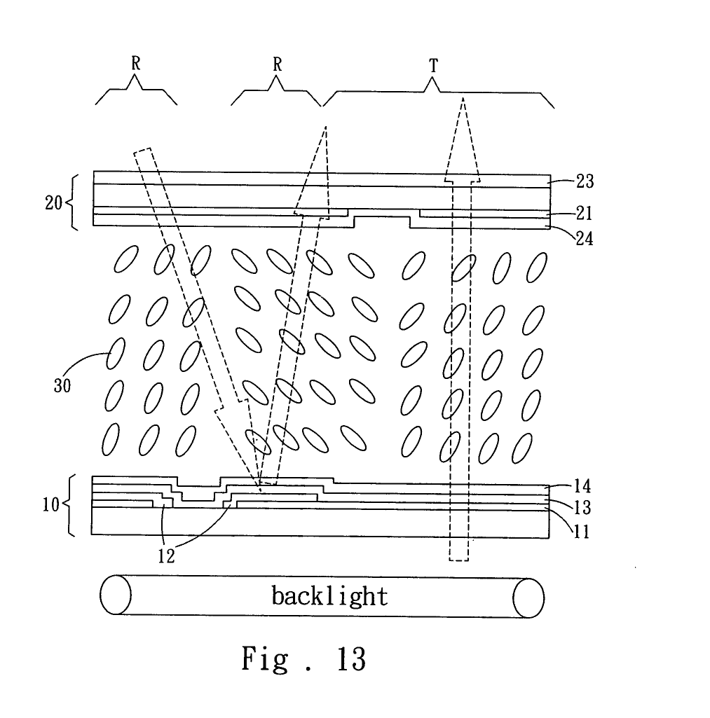

As FIG. 13 indicates, when the drive voltage is applied to the LC, in the transmissive region, the molecules of the LC cells 30 are tilted down around the pixel electrode 11 and the top electrode 21 due to the electric field of the fringes in vertical direction. The arrangement of the long axes of LC molecules is perpendicular to the direction of the applied voltage. When the backlight passes through the polarizing layer 13 and the LC cells 30, the polarization direction of the polarized light is not perpendicular to the polarization axis of the porlarizer 23 on the second substrate 20, so that the light passes through to produce a bright frame.

As for in the reflective region R, the molecules of the LC cells 30 are tilted down around the pixel electrode 11 and the top electrode 21 due to the electric field of the fringes in vertical direction, and the arrangement of the long axes of LC molecules is perpendicular to the direction of the applied voltage. When the outside light passes through the polarizer 23 on the surface of the second substrate 20 and through the LC cells 30, the polarization direction of the polarized light is not perpendicular to the polarization axis of the porlarizing layer 13 on the first substrate 10. The outside light is reflected by the reflection layer 12 and passes through the LC cells 30, and the polarized direction of the reflection light is not perpendicular to the polarized direction of the polarizer 23 on the second substrate 20. The reflection light passes to produce a bright frame.

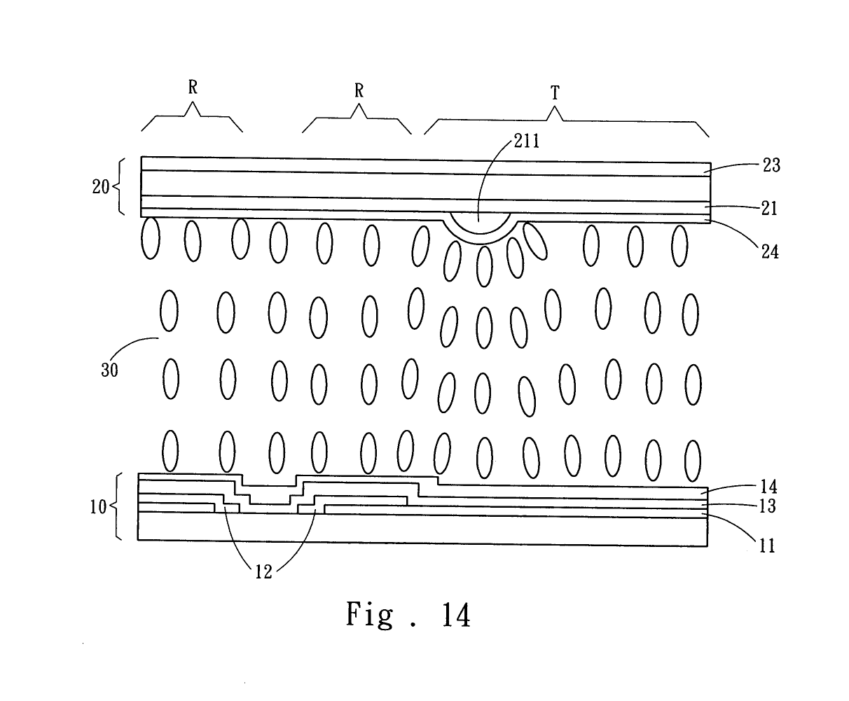

FIG. 14 shows the second schematic diagram of the LCD structure of the invention. As FIG. 14 indicates, the top electrode 21 on the second substrate 20 includes at least one point-like bump 211, which is different from the FIG. 8, and the top electrode 21 and the bump 211 are covered with an alignment film 24. The bump 211 and the slit structure 110 of the pixel electrode 11 are separated in the vertival direction, i.e. both do not overlap each other. The patterns of the slit structure 110 and the bump 211 can be as FIGS. 10A to 10G and FIGS. 11 to 11F.

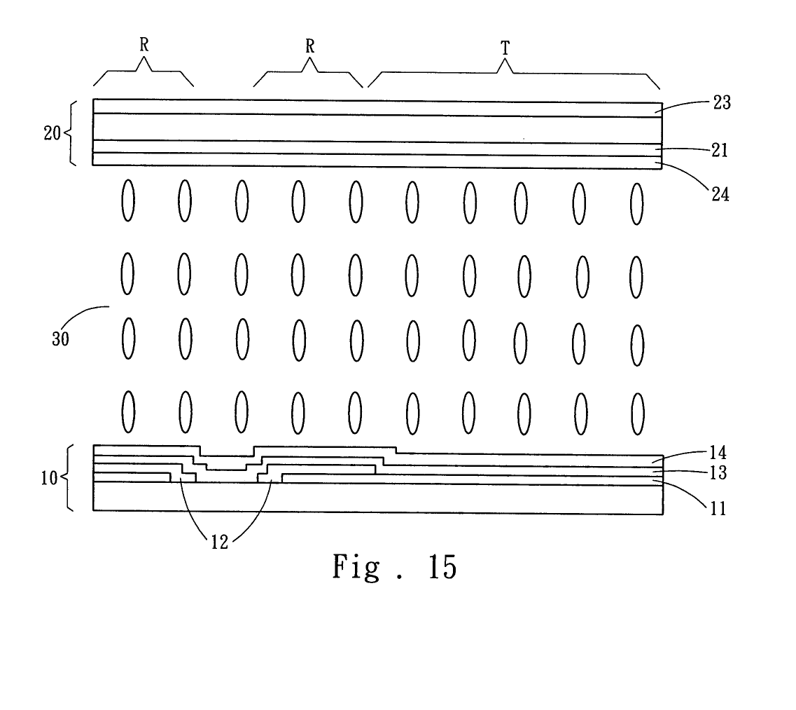

Another construction is that the top electrode 21 is a flate plane covered with an alignment film 24, as shown in FIG. 15. Finally, the LC cells 30 are established between the first substrate 10 and the second substrate 20.

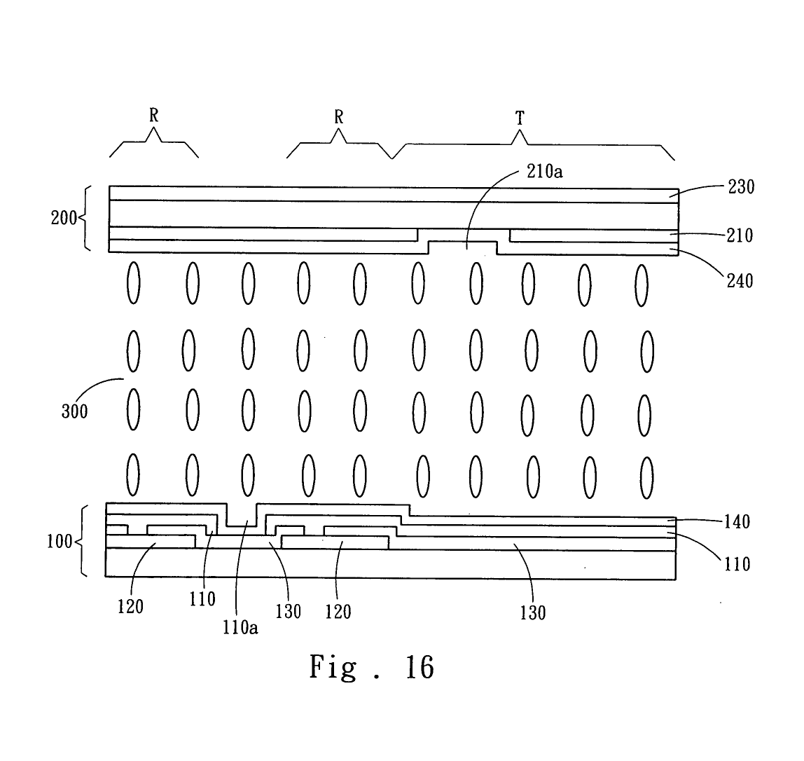

FIG. 16 shows the fourth schematic diagram of the LCD structure of the invention. As FIG. 16 indicates, the construction has the first substrate 100, and the pattern of the reflection layer 120 is formed on the substrate by an etching process to define the reflective region R and the transmissive region T. The reflection layer 120 is a metal material (e.g., Al, Ag, Cr, AlNd and so on) with low resistivity and high reflection character. Besides, the first substrate 100 contains TFTs, and the reflection layer 120 and the first substrate 100 are covered with the polarizing layer 130, wherein at least one open window is formed to expose the reflection layer 120. Then, the pixel electrode 110 is constructed on the polarizing layer 130, and the electrode 110 forms the slit structure 110a by an etching process, and the electrode 110 covers the reflection layer 120. The slit structure 110a is established around the pattern of the reflection layer 120. Finally, the electrode 110 is covered with the alignment film 140.

The second substrate 200 contains a color filter and is established with a top electrode 210. The outside surface of the substrate 200 contains a polarizer 230. The direction of the polarization axis of the polarizer 230 is orthogonal to the polarizing layer 130. The top electrode 210 includes at least one point-like bump 210a, and the top electrode 210 and the bump 210a are covered with an alignment film 240. The slit structure 210a of the top electrode 210 and the slit structure 110a of the pixel electrode 110 are separated in the vertival direction, as shown in FIG. 9, FIGS. 10A to 10G and FIGS. 11A to 11F. The slit structures 110a and 210a are fabricated on the center of the pixel electrode. Finally, the LC cells 30 are established between the first substrate 100 and the second substrate 200.

The principles of the wide viewing angle and the reflective function, as mentioned above, are summarized: to use the arrangement of the slit structure 110a of the pixel electrode 110 and the slit structure 210a of the top electrode 210 and to form the effect of multi-domain semi-transmissive wide viewing angle by adjusting the relative positions of the slit structures 110a and 210a and by using the fringe effect of electric field of the slit structures 110a and 210a to control the tilt directions of the LC molecules 300. Besides, by using the reflective region made of the reflection layer 120 under the pixel electrode 110, when the light passes through the polarizer 230 and the LC cell 300, the reflective region R and the transmissive region T have the same polarized direction to achieve the semi-transmissive and semi-reflective effect.

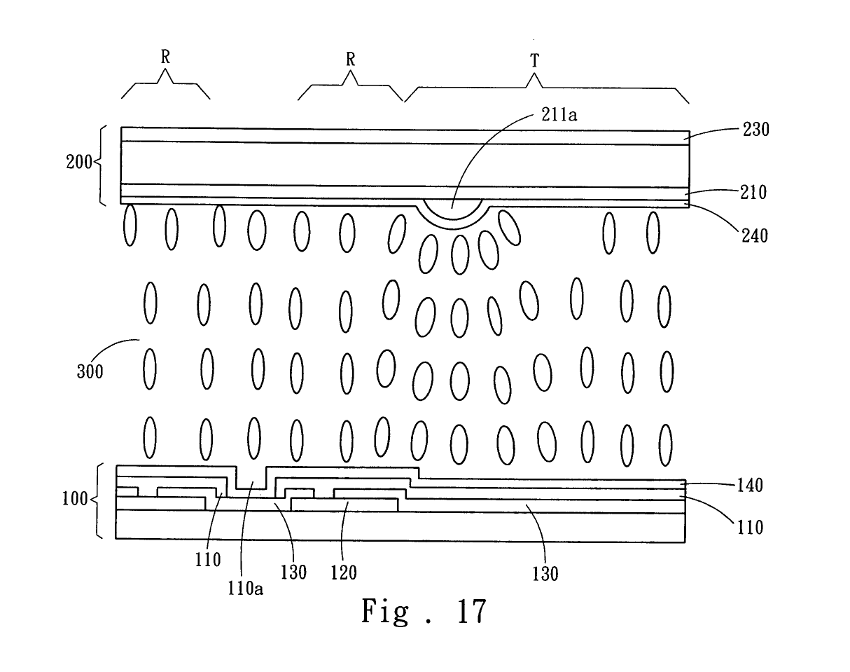

FIG. 17 shows the fifth schematic diagram of the LCD structure of the invention. As FIG. 17 indicates, the top electrode 210 on the second substrate 200 includes at least one point-like bump 211a, which is different from the FIG. 16, and the top electrode 210 and the bump 211a are covered with the alignment film 240. The bump 211a and the slit structure 110a of the pixel electrode 110 are separated in the vertival direction. The patterns of the slit structure 110a and the bump 211a can be as FIGS. 10A to 10G and FIGS. 11A to 11F.

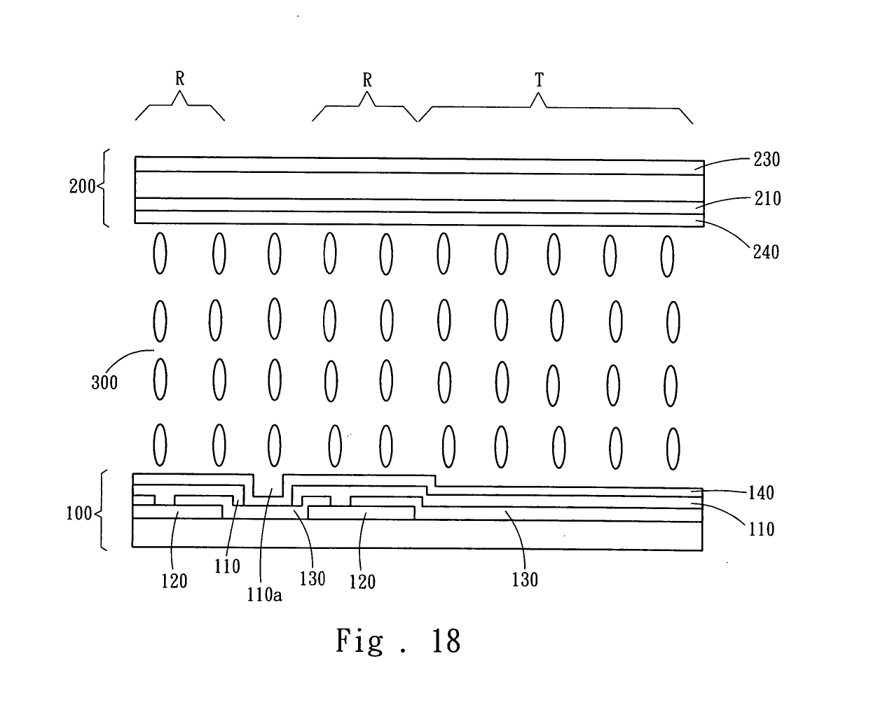

Another construction is that the top electrode 210 on the second substrate 200 is a flate plane covered with an alignment film 240, as shown in FIG. 18. Finally, the LC cells 300 are established between the first substrate 100 and the second substrate 200.

To sum up, the invention is based on the function of the wide viewing angle to define the transmissive region and the reflective region at the pixel electrode, thereby the wide viewing angle LCD with reflective effect is formed. By using the fringe effect of electric field in the vertical direction, the different tilt directions of the LC molecules are controlled, and the LCD with reflective function and vertical alignment of multi-domain division is constructed. Compared with the previous tecknologies, the invention has the merits that the slits form the wide viewing angle and the light in the transmissive and reflective regions is used totally.

While the above mentions are some better examples for demonstration, but not the limitation of application in this invention. All the homogeneous modification and variations of the invention are included in what is claimed in this invention.

What is claimed is:

1. A structure of LCD (liquid crystal display) with a wide viewing angle, comprising:
a first substrate, wherein a pixel electrode is established on the first substrate, and the pixel electrode has slit structures;
a reflection layer which is established around the slit structures of the pixel electrode and covers a part of the pixel electrode;
a polarizing layer which covers the reflection layer and the pixel electrode;
a first alignment film which covers the polarizing layer;
a second substrate, wherein an electrode is established on a surface of the second substrate faced to the first substrate;
a second alignment film which covers a top electrode; and
a LC cell which is established between the first alignment film and the second alignment film.

2. The structure of LCD with a wide viewing angle of claim 1, wherein the first substrate includes at least one TFT.

3. The structure of LCD with a wide viewing angle of claim 1, wherein the polarizer is established on the surface of the second substrate and the direction of a polarization axis of the polarizer is orthogonal to the polarizing layer.

4. The structure of LCD with a wide viewing angle of claim 1, wherein the second substrate further includes one color filter.

5. The structure of LCD with a wide viewing angle of claim 1, wherein a slit structure of the pixel electrode includes at least one point-like slit.

6. The structure of LCD with a wide viewing angle of claim 1, wherein the reflection layer is a metal material with low resistivity and high reflection character.

7. The structure of LCD with a wide viewing angle of claim 1, wherein the slit structure of the top electrode and the slit structure of the pixel electrode are separated in the vertival direction.

8. The structure of LCD with a wide viewing angle of claim 7, wherein the slit structure of the top electrode includes at least one point-like slit.

9. The structure of LCD with a wide viewing angle of claim 1, wherein the top electrode includes at least one bump structure and the bump structure and the slit structure of the pixel electrode are separated in the vertival direction.

10. The structure of LCD with a wide viewing angle of claim 9, wherein the bump structure of the top electrode includes at least one point-like bump.

11. A kind of structure of LCD (liquid crystal display) with a wide viewing angle, comprising:
a first substrate, wherein a pattern of a reflection layer is established on the first substrate;
a polarizing layer which covers the reflection layer and the first substrate;
a pixel electrode which is established on the surface of the polarizer layer and covers a reflective region and further has slits around the pattern of the reflection layer;
a first alignment film which covers the pixel electrode;
a second substrate, wherein a top electrode is established on the surface of the second substrate faced to the first substrate;
a second alignment film which covers the top electrode; and
a LC cell which is established between the first alignment film and the second alignment film.

12. The structure of LCD with a wide viewing angle of claim 11, wherein the polarizer is established on the surface of the second substrate and the direction of a polarization axis of the polarizer is orthogonal to the polarizing layer.

13. The structure of LCD with a wide viewing angle of claim 11, wherein the first substrate includes at least one TFT.

14. The structure of LCD with a wide viewing angle of claim 11, wherein the second substrate further includes one color filter.

15. The structure of LCD with a wide viewing angle of claim 11, wherein a slit structure of the pixel electrode includes at least one point-like slit.

16. The structure of LCD with a wide viewing angle of claim 11, wherein the reflection layer is a metal material with low resistivity and high reflection character.

17. The structure of LCD with a wide viewing angle of claim 11, wherein the top electrode includes at least one slit structure, and the slit structure and the slit structure of the pixel electrode are separated in the vertival direction.

18. The structure of LCD with a wide viewing angle of claim 17, wherein the slit structure of the top electrode includes at least one point-like slit.

19. The structure of LCD with a wide viewing angle of claim 11, wherein the top electrode includes at least one bump structure and the bump structure and the slit structure of the pixel electrode are separated in the vertival direction.

20. The structure of LCD with a wide viewing angle of claim 19, wherein the bump structure of the top electrode includes at least one point-like bump.
